(19) United States
(12) Patent Application Publication
(10) Pub. No.: US 2006/0280884 A1
(43) Pub. Date: Dec. 14, 2006

(54) Apparatus and method for providing the attachment of a reverse hand-painted decorative art within a glass vessel

(76) Inventors: James P. Sexton, Hickory Creek, TX (US); Michael P. Thalasinos, Flower Mound, TX (US)

Correspondence Address: LAW OFFICES OF JAMES E. WALTON, PLLC, 1169 N. BURLESON BLVD., SUITE 107-328, BURLESON, TX, 76028, US

(21) Appl. No.: 11/151,367

(22) Filed: Jun. 13, 2005

(51) Int. Cl. B28B 11/00

(52) U.S. Cl. 428/34.4

(57) ABSTRACT

An apparatus and method is disclosed for providing the attachment of a reverse hand-painted decorative art within a glass vessel. The glass vessel comprises at least one exterior glass article, at least one interior glass article capable of attaching to at least one exterior glass article, a first access port associated with the interior portion of the at least one interior glass article, and a second access port associated with the interior portion of the at least one exterior glass article. The glass vessel further comprising the at least one interior glass article capable of being reverse hand-painted on the interior portion of the at least one interior glass article through at least one first access port.

### BACKGROUND

1. Field of the Invention

The present invention relates generally to reverse hand-painted glass articles and, more specifically, to an apparatus and method for providing the attachment of a reverse hand-painted decorative art within a glass vessel.

2. Description of Related Art

The art of glass fabrication using various glass blowing techniques is an ancient art form. A typical glass fabricating method includes the heating of a glass-like substance or material until it is in the proper condition to be accumulated on the end of a blowpipe. The accumulation of this glass-like substance or material is typically known as a “gather”. A skilled glass blower will then heat the gather until it is at the proper viscosity to be blown. These glass blowers are able to blow the gather to form a hollow object of substantially any shape, such as a cylinder, sphere, or the like.

Over the years, the talents of glass blowers have combined their glass-blowing talents with the talents of various other artists to create new forms of art. In particular, a skilled group of artists known as “reverse hand-painting artists” have combined their talents with those of the glass blowers to form hollow glass objects in the shape of decorative glass ornaments. The reverse hand-painting artists utilize their skills by hand-painting beautiful images on the inside of the glass-blown decorative glass ornaments. It is not uncommon for reverse hand-painting artists to differentiate their work from other artists by etching or reverse hand-painting their signature into the decorative glass ornaments. This process authenticates their art from other reverse hand-painting artists.

However, one problem with these beautiful decorative hand-painted glass ornaments is that because they are created with such fine detail-type workmanship, it is difficult to gain a full appreciation of the artwork with the naked eye. Often in order to gain a full appreciation of the reverse hand-painting artist's creation, a close inspection of the artwork is required. Furthermore, another problem is that these decorative hand-painted glass ornaments are too fragile to display and must be suspended to protect their delicate nature. Typically the method of displaying these beautiful decorative hand-painted glass ornaments is by means of either hanging or by placing the ornament on a supporting stand. Therefore these decorative hand-painted glass ornaments require some sort of hanging mechanism, such as a braided cord or tassel to allow a purchaser the option of hanging the decorative hand-painted glass ornament.

Although great strides have been made in the area of hand-painted ornaments, many short comings remain.

### SUMMARY OF THE INVENTION

There is a need in the art for providing an apparatus and method for providing the attachment of a reverse hand-painted decorative art within a glass vessel. There is also a need for providing a magnification or amplification of the visual appearance of the reverse hand-painted decorative art from the perspective of visual observance outside of the glass vessel. Therefore, it is an object of the present invention to provide an apparatus and method for providing the attachment of a reverse hand-painted decorative art within a glass vessel.

This object is achieved by providing a glass vessel comprising at least one exterior glass article, at least one interior glass article capable of attaching to at least one exterior glass article. According to the preferred embodiment of the present invention, the glass vessel comprises a first access port associated with the interior portion of the at least one interior glass article and a second access port associated with the interior portion of the at least one exterior glass article.

According to an alternate embodiment of the present invention, the glass vessel further comprises the at least one interior glass article capable of being reverse hand-painted on the interior portion through at least a first access port and the at least one exterior glass article is capable of being reverse hand-painted on the interior portion of through at least a second access port.

According to still another embodiment of the present invention, the glass vessel comprises a substance capable of being added through the second access port to at least partially cover the at least one interior glass article and the substance provides amplification of the visual appearance of the at least one interior glass article from the perspective of visual observance outside of the glass vessel.

It is another object of the present invention to provide a system for the attachment of decorative art within a glass vessel.

This object is achieved by providing a painted vessel comprising a first hollow article, a second hollow article disposed within the interior of the first hollow article, a first access port for providing access to the interior of the first hollow article, a second access port for providing access to the interior of the second hollow article, and an image disposed on the interior surface of the second hollow article.

According to yet another embodiment of the present invention, the painted vessel further comprises the second hollow article coupled to the first hollow article so as to form a fluid-tight seal and are formed from blown glass. The painted vessel further comprises the image reverse hand-painted through the second access port.

It is still another object of the present invention to provide a method for the attachment of decorative art within a glass vessel.

This object is achieved by providing a method comprising the steps of heating glass material accumulated on the end of a first glass blowing element to form at least one interior glass article in the shape of a substantially hollow object, forming an attachment portion at a base portion of the at least one interior glass article, heating glass material accumulated on the end of a second glass blowing element to form at least one exterior glass article in the shape of a substantially hollow object, and forming an attachment portion at a base portion of exterior glass article operable to receive the at least one of the interior glass articles.

According to yet another embodiment of the present invention, the method includes re-heating the at least one interior glass article, re-heating the at least one exterior glass article, and placing the at least one exterior glass article and the at least one interior glass article in contact with each other to form a seamless one-piece decorative art glass vessel in combination with the at least one interior glass article.

The present invention provides the following advantages: (1) more easily seen; (2) exterior glass article acts as a magnifying lens; (3) more decorative; and (4) are easier to display without the need for a suspending device.

These and other advantages and features of the present invention will become readily apparent to those skilled in the art upon examination of the subsequent detailed description and accompanying drawings. Accordingly additional advantages and features of the present invention and the scope thereof are pointed out with particularity in the claims and form a part hereof.

### DESCRIPTION OF THE DRAWINGS

The novel features believed characteristic of the invention are set forth in the appended claims. However, the invention itself, as well as a preferred mode of use, and further objectives and advantages thereof, will best be understood by reference to the following detailed description when read in conjunction with the accompanying drawings, wherein:

FIG. 1 illustrates a glass vessel in accordance with the preferred embodiment of the present invention;

FIG. 2A illustrates an interior glass article of the glass vessel of FIG. 1.

FIG. 2B illustrates an exterior glass article of the glass vessel of FIG. 1.

FIG. 3 illustrates a glass vessel in accordance with an alternate embodiment of the present invention; and

FIG. 4 illustrates a high-level flowchart of a process for providing the attachment of reverse hand-painted decorative art within a glass vessel, in accordance with the preferred embodiment of the present invention.

### DETAILED DESCRIPTION OF THE PREFERRED EMBODIMENT

Reference will now be made to the following detailed description of the preferred and alternate embodiments of the present invention. Those skilled in the art will recognize that the present invention provides many inventive concepts and novel features, that are merely illustrative, and are not to be construed as restrictive. Accordingly, the specific embodiments discussed herein are given by way of example and do not limit the scope of the present invention.

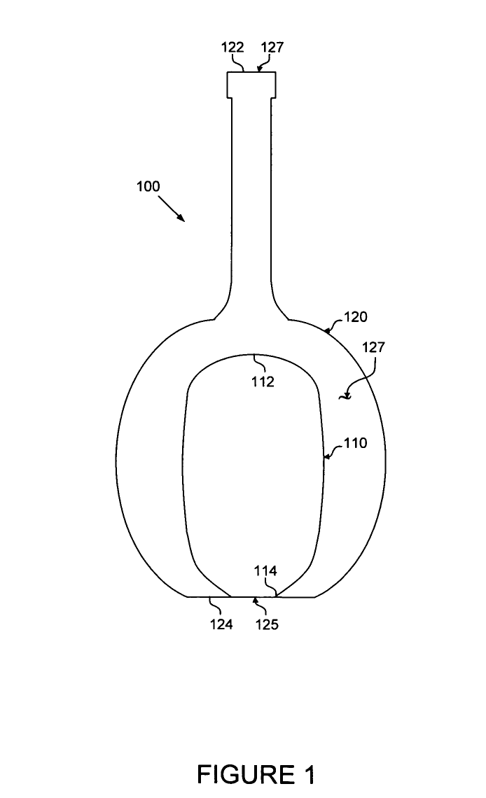

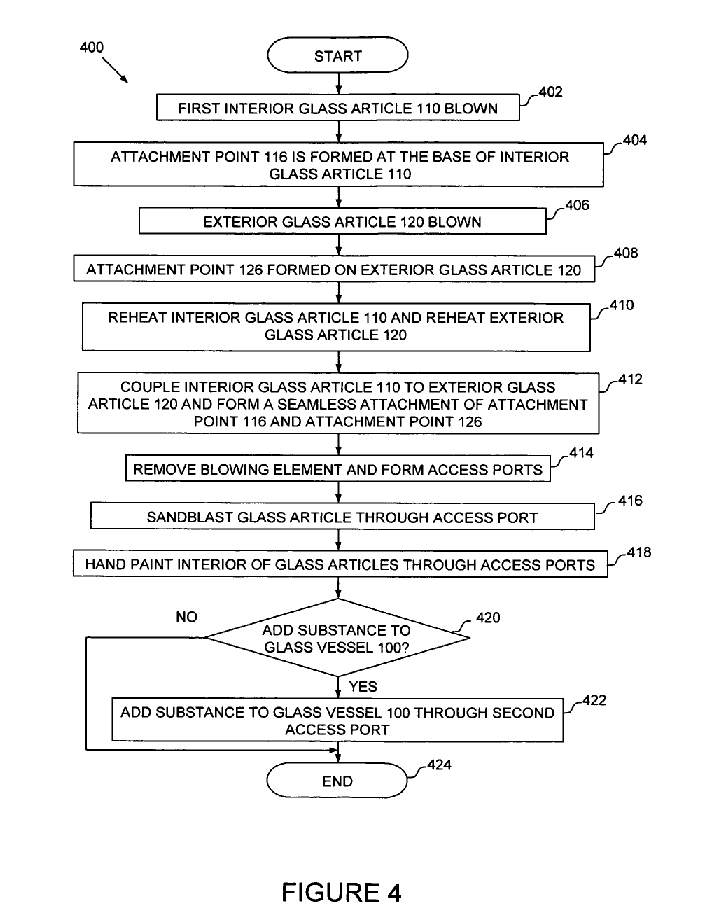

Referring now to FIG. 1 in the drawings, the preferred embodiment of a glass vessel 100 according to the present invention is illustrated. Glass vessel 100 comprises an interior glass article 110 coupled to an exterior glass article 120. Interior glass article 110 comprises a top portion 112 and a base portion 114. Top portion 112 represents the furthest point of interior glass article 110 from a glass blowing element (not shown) during the glass blowing process, as explained in greater detail below. Interior glass article 110 is preferably coupled to exterior glass article 120 at base portion 114. As will be explained below in greater detail with respect to FIG. 4, base portion 114 is accumulated on the end of the glass blowing element to form interior glass article 110 during the glass blowing process. Exterior glass article 120 comprises a top portion 122 and a base portion 124. Base portion 124 may be configured for supporting glass vessel 100 in a self standing position without the need or support of suspending devices. As will be explained below in greater detail with respect to FIG. 4, top portion 122 is accumulated on the end of a second glass blowing element (not shown) to form exterior glass article 120, during the glass blowing process.

In the preferred embodiment of the present invention, base portion 124 of exterior glass article 120 is formed to base portion 114 of interior glass article 110 to form a seamless, one-piece glass vessel 100. Additionally, the attachment of base portion 124 to base portion 114 provides a first access port 125 into the interior portion of interior glass article 110. The interior portion of glass article 110 is capable of being reverse hand-painted through first access port 125. Top portion 122 provides a second access port 127 into the interior portion of exterior glass article 120. The interior portion of exterior glass article 120 is capable of being reverse hand-painted, through second access port 127. In addition, the exterior portion of interior glass article 110 is capable of being hand-painted, through second access port 127. After painting, first access port 125 may be sealed such that a void space 129 between the exterior surface of interior glass article 110 and the interior surface of exterior glass article 120 is capable of being filled with a substance, for example, fluid, oil, water, or the like.

Those skilled in the art will recognize that first access port 125 and second access port 127 are given by way of example and that the present invention is not limited to a first access port at the base portion of glass vessel 100 and a second access port at the top portion of glass vessel 100. For example, a first access port may be located at the base portion of glass vessel 100 and a second access port may also be located in close proximity to the first access port at the base portion of glass vessel 100. In an alternative embodiment (not shown), glass vessel 100 may comprise a second access port of exterior glass article 120 on one of the side portions or on the base portion of glass vessel 100. In another alternate embodiment (not shown), glass vessel 100 may comprise at least one of a plurality of second access ports associated with exterior glass article 120. In another alternate embodiment (not shown), the at least one of a plurality of first access ports of the at least one of a plurality of interior glass articles and the at least one of a plurality of second access ports are capable of being sealed to provide a substantially waterproof seal.

Although glass vessel 100 is shown and described as having a shape substantially similar to a vase, it should be understood that the present invention is not limited to a glass vessel shaped in the form of a vase. Other types of shapes and forms may be used for glass vessel 100, including lamps, wine decanters, candle stands, snow globes, aquariums or fish bowls, or the like. For the sake of simplicity, only a glass vessel shaped in the form of a vase is shown and discussed herein. Those skilled in the art will understand that glass vessel 100 comprising at least one interior glass article 110 and at least one exterior glass article 120 are given by way of example only and should not be construed to limit the types of glass articles in which the present invention may be implemented. However, for the purposes of defining the scope of the claims of the present invention, the term glass vessel and any other term used to denote glass vessel 100 should be construed broadly to include substantially any shape or form of an exterior glass article capable of attaching to any other shape or form of an interior glass article capable of being reverse hand-painted.

In the preferred embodiment of the present invention, glass vessel 100 is blown, using glass blowing techniques with translucent glass material or substantially transparent glass material. Alternatively, glass vessel 100 may be blown using glass blowing techniques with opaque glass material, colored glass material, or the like. In essence, interior glass article 110 may be blown using glass blowing techniques that provide for a first glass material, and exterior glass article 120 may be blown using glass blowing techniques that provide for a second glass material, thereby creating a multi-glass vessel 100 using at least one of a plurality of glass materials.

It is understood that glass vessel 100 is given by way of example and that, for simplicity and clarity, only so much of the construction and operation of glass vessel 100 as is unique to the present invention or necessary for an understanding of the present invention is shown and described. Moreover, although glass vessel 100 is shown as having only a first interior article 100, in an alternate embodiment (not shown), glass vessel 100 comprises at least one of a plurality of interior glass articles comprising at least one of a plurality of first access ports. In another alternate embodiment (not shown), the interior portion of at least one of the plurality of interior glass articles is capable of being reverse hand-painted through at least one of the plurality of first access ports. Although a preferred embodiment has been described as reverse hand-painting, it should be understood that an image may be disposed on the interior or exterior portions of glass vessel 100 using reverse hand-painting, hand-painting, spray-painting, machine-painting or the like.

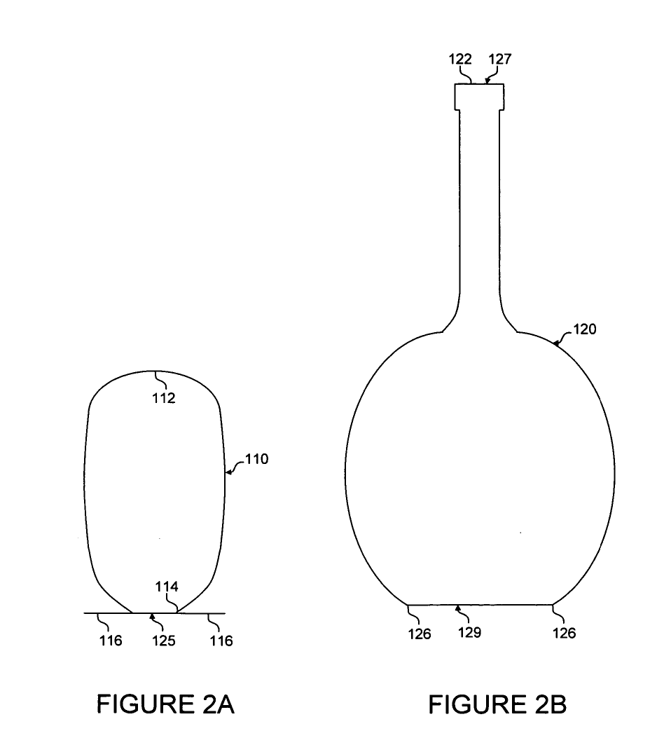

Referring now to FIG. 2A in the drawings, the preferred embodiment of an interior glass article 110 according to the present invention is illustrated. Interior glass article 110 comprises top portion 112, base portion 114, and attachment portion 116. Interior glass article 110 further comprises a first access port 125 into the interior portion of interior glass article 110. As described below in more detail with respect to FIG. 4, the glass material comprising interior glass article 110 is accumulated on the end of the first glass blowing element to provide for the forming of interior glass article 110. The heated glass material, accumulated on the end of a first glass blowing element, is blown to form interior glass article 110, which is preferably a substantially hollow object. Then, attachment portion 116 is formed at the base portion of interior glass article 110, which enables the attachment of interior glass article 110 to exterior glass article 120.

Referring now to FIG. 2B in the drawings, the preferred embodiment of an exterior glass article 120 according to the present invention is illustrated. Exterior glass article 120 comprises top portion 122 and attachment portion 126. As described below in more detail with respect to FIG. 4, the glass material comprising exterior glass article 120 is accumulated on the end of the second glass blowing element to provide for the forming of exterior glass article 120. The heated glass material, accumulated on the end of the second glass blowing element is blown to form exterior glass article 120, which is preferably a substantially hollow object, having a with an opening configured to receive interior glass article 110. Attachment portion 126 is the point at the base portion of exterior glass article 120 which is capable of receiving the attachment of interior glass article 110. It should be understood that the glass material comprising interior glass article 110 may be inserted into the already blown exterior glass article 120, then interior glass article 110 may be formed subsequent to the forming of exterior glass article 120.

In an alternative embodiment of the present invention, a glass blowing mold (not shown) may be used with glass blowing techniques to form interior glass article 110 and/or exterior glass article 120. To further explain the operation of a mold, an example is now given. In the following example, interior glass article 110 may be blown using a first glass blowing element within a glass blowing mold comprising a sphere-shaped interior. As interior glass article 110 is blown through the first glass blowing element and makes contact with the interior sphere-shaped glass blowing mold, interior glass article 110 is formed and replicates the shape of the glass blowing mold. Accordingly, different glass blowing molds may be used to achieve different shapes or appearances of interior glass article 110. Additionally, different glass blowing molds may be used to achieve various shapes and appearances of exterior glass article 120. Those skilled in the art will recognize that the glass blowing mold comprising a sphere-shaped interior is given by way of example and that the present invention is not limited to the use of glass blowing molds comprising a sphere-shaped interior.

The embodiments of the present invention shown and described in FIGS. 2A and 2B provide for the coupling, preferably by fusing, of at least one of a plurality of interior glass articles 110 to at least one of a plurality of exterior glass articles 120. Those skilled in the art will understand that the glass blowing techniques used in association with the forming and coupling of at least one interior glass article 110 to at least one exterior glass article 120 are given by way of example only and should not be construed to limit the scope or type of glass blowing techniques in which the present invention may be implemented. In addition, the glass blowing element described in association with interior glass article 110 and exterior glass article 120 may be for example, a glass tube, a glass blowpipe, a handling rod, or the like. Additionally, while the coupling of interior glass article 110 and exterior glass article 120 are shown and described as using a substantially manual technique, glass lathes or other types of mechanical assembly techniques are within the scope of the present invention.

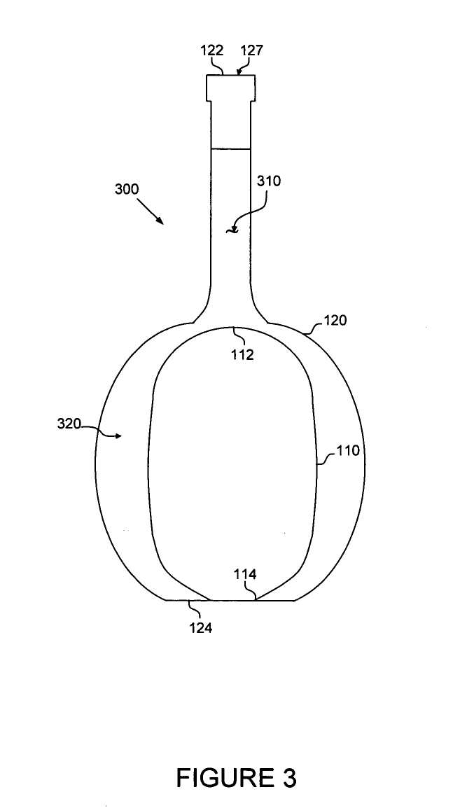

Referring now to FIG. 3 in the drawings, the preferred embodiment of a glass vessel 300 according to the present invention is illustrated. Glass vessel 300 is similar in form to glass vessel 100, in that glass vessel 300 comprises interior glass article 110 coupled to exterior glass article 120 with the exception that a substance 310 is disposed in a void space 320. Interior glass article 110 comprises top portion 112 and base portion 114 coupled to exterior glass article 120. Exterior glass article 120 comprises top portion 122 and base portion 124. The attachment of base portion 124 of exterior glass article 120 to base portion 114 of interior glass article 110 provides a first access port into the interior portion of interior glass article 110. Additionally, top portion 122 provides a second access port into the interior portion of exterior glass article 120. In this embodiment substance 310 is added through second access port 127 of top portion 122.

When substance 310 is added to void space 320 to at least partially cover interior glass article 110, substance 310 amplifies or magnifies the visual appearance of interior glass article 110 from the perspective of visual observance outside of glass vessel 100. Those skilled in the art will recognize that the functionality described herein may be readily adapted to other types of substances capable of at least partially filling glass vessel 100. In an alternative embodiment (not shown), substance 310, may be for example a fluid, such as colored fluids, water, oils, liquor, juice, or the like or combinations thereof, and may include particle matter to accentuate the decorative nature of glass vessel 300, such as glitter, plastic flakes, or the like. In an alternate embodiment (not shown), substance 310 may comprise other non-fluid substances, for example, potpourri, sand, various flake like materials, fish or the like. Additionally, the magnification or amplification of interior glass article 110 may be adjusted depending upon the characteristics of substance 310 or the distance between interior glass article 110 and exterior glass article 120.

In an alternative embodiment (not shown), glass vessel 300 may be in the shape of an oil lamp base. Accordingly, substance 310 may be for example a fluid such as oil, flammable liquid, or the like. In such embodiments top portion 122 may comprise a wick element (not shown) that allows for the wicking and burning of substance 310 from glass vessel 300.

Referring now to FIG. 4 in the drawings, the preferred embodiment of a high-level flowchart 400 of a process for providing the attachment of reverse hand-painted decorative art within a glass vessel according to the present invention is illustrated. Flowchart 400 starts at step 402 with the forming of interior glass article 110. The glass material comprising interior glass article 110 is heated until it is in the proper condition and the proper viscosity to be blown. The heated glass material is blown to form interior glass article 110, which is substantially a hollow object of substantially any shape, such as a cylinder, sphere, or the like. Next, in step 404, attachment portion 116 is formed at base portion 114 of interior glass article 110, which will enable the coupling of interior glass article 110 to exterior glass article 120, as described below in more detail. It is recalled from the discussion above with respect to FIG. 1 that base portion 114 of interior glass article 110 is preferably located at the point where the first glass blowing element is attached.

The process continues with step 406, with the forming of exterior glass article 120. The glass material comprising the exterior glass article 120 is heated until it is in the proper condition and the proper viscosity to be blown. The heated glass material is blown to form exterior glass article 120, which is a substantially hollow object, except that base 124 is partially formed to allow opening 129 configured to receive interior glass article 110. Next, in step 408, attachment portion 126 is formed at base 124 of exterior glass article 120. Attachment portion 126 provides a means for coupling exterior glass article 120 to interior glass article 110. It is recalled from the discussion above with respect to FIG. 1 that base 124 of exterior glass article 120 is located at the opposite point from where the second glass blowing element is attached.

Next, as represented by step 410, interior glass article 110 is coupled to partially blown exterior glass article 120 to form a seamless one-piece glass vessel 100. Interior glass article 110 is re-heated and maintained at a temperature to provide for a tacky surface. Likewise, exterior glass article 120 is re-heated and maintained at a temperature to provide for a tacky surface. The process continues with step 412, in which attachment portion 116 of interior glass article 110, which is at an elevated temperature, and attachment portion 126 of the exterior glass article 120, which is also at an elevated temperature, are placed into contact with each other and are fused together. Additional heat is applied to glass vessel 100, comprising interior glass article 110 and partially blown exterior glass article 120, to allow attachment portions 116 and 126 to form a seamless, one-piece glass vessel 100.

Then, in step 414, first access port 125 of glass vessel 100 is formed by removing the first glass blowing element from interior glass article 110. Likewise second access port 127 of glass vessel 100 is formed by removing the second glass blowing element from exterior glass article 120. Glass vessel 100 may be trimmed, using glass trimming techniques, in the area surrounding the location of the first access port and the second access port. In addition, glass vessel 100 may be subjected to other post-processing techniques and treatments, such as etching may be desired.

After glass vessel 100 has sufficiently cooled off, in step 416, first interior glass article 110 is preferably sandblasted through first access port 125. The sandblasting of the interior portion of interior glass article 110 is provided to achieve a substantial improvement of adhesion of any paint that may be applied in the hand-painting in step 418, below. Additionally, sandblasting may also be conducted on the interior portion of exterior glass article 120 and/or the exterior portion of interior glass article 110 through second access port 127, to provide a substantial improvement of the adhesion of paint to either the interior of exterior glass article 120 or the exterior of interior glass article 110, if so desired. Alternatively, the sandblasting of interior glass article 110 and exterior glass article 120 may be completed at any time during the process. In addition, sandblasting of the exterior portions of interior glass article 110 or exterior glass article 120 may be done to achieve an aesthetic appearance in any visual form or pattern.

Next, in step 418, the interior portion of interior glass article 110 is reverse hand-painted through first access port 125. As described above in step 416, it may be desirable to hand-paint the interior portion of exterior glass article 120. If so, at this stage in the process the interior portion of exterior glass article 120 is reverse hand-painted through second access port 127. Likewise it may be desirable to hand-paint the exterior portion of interior glass article 110 or the exterior portion of exterior glass article 120. If so, at this stage in the process the exterior portion of interior glass article 110 or exterior glass article 120 may be hand-painted.

The process continues with inquiry step 420, in which a determination is made as to whether a substance, such as substance 310 is to be added to glass vessel 100. If a substance is not to be added to glass vessel 100, the process ends at step 424. On the other hand, if a substance is to be added to glass vessel 100, the process continues with step 422.

Next, in step 422, substance 310 is added to glass vessel 100 through second access port 127. Substance 310 is added to at least partially cover interior glass article 110, thereby amplifying or magnifying the visual appearance of interior glass article 110 from the perspective of visual observance exterior to glass vessel 100. In an alternative embodiment (not shown), the substance added to glass vessel 100, may comprise colored liquid, oils, various flake like materials, fish, potpourri, or the like.

While the exemplary embodiments of the present invention have been shown and described, it will be understood that various changes and modifications to the foregoing embodiments may become apparent to those skilled in the art without departing from the spirit and scope of the present invention. Accordingly, the invention is not limited to the embodiments disclosed, but rather by the appended claims and their equivalents.

What is claimed is:

1. A glass vessel, comprising:
at least one exterior glass article;
at least one interior glass article disposed within the at least one exterior glass article;
at least one first access port associated with an interior portion of the at least one interior glass article; and
at least one second access port associated with an interior portion of the at least one exterior glass article.

2. The glass vessel according to claim 1, further comprising:
an image disposed on an interior surface of the at least one interior glass article.

3. The glass vessel according to claim 2, wherein the image is a reverse hand-painted image painted through the at least one first access port.

4. The glass vessel according to claim 1, further comprising:
an image disposed on an interior surface of the at least one exterior glass article.

5. The glass vessel according to claim 4, wherein the image is a reverse hand-painted image painted through the at least one second access port.

6. The glass vessel according to claim 2, further comprising:
a void space defined by an exterior surface of the at least one interior glass article and an interior surface of the at least one exterior glass article; and
a substance disposed in the void space, the substance at least partially covering the exterior surface of the at least one interior glass article.

7. The glass vessel according to claim 6, wherein the substance comprises at least one of:
a colored liquid;
a liquor;
a water-based liquid;
a flammable liquid;
a oil-based liquid; and
a combination of liquid and particulate matter.

8. The glass vessel according to claim 6, wherein the substance amplifies the visual appearance of the image.

9. The glass vessel according to claim 1, wherein the interior glass article is fused to the exterior glass article to form a fluid-tight seal.

10. The glass vessel according to claim 1, wherein the at least one exterior glass article is an oil lamp base.

11. A painted vessel, comprising:
a first hollow article;
a second hollow article disposed within the interior of the first hollow article;
a first access port for providing access to the interior of the first hollow article;
a second access port for providing access to the interior of the second hollow article; and
an image disposed on the interior surface of the second hollow article.

12. The painted vessel according to claim 11, wherein the second hollow article is coupled to the first hollow article so as to form a fluid-tight seal.

13. The painted vessel according to claim 11, wherein the first hollow article and the second hollow article are formed from blown glass.

14. The painted vessel according to claim 11, wherein the image is a reverse hand-painted image painted through the second access port.

15. The painted vessel according to claim 11, further comprising:
a reverse hand-painted image disposed on an interior surface of the first hollow article.

16. The painted vessel according to claim 11, further comprising:
a substance disposed between the first hollow article and the second hollow article.

17. The painted vessel according to claim 16, wherein the substance comprises at least one of:
a colored liquid;
a liquor;
a water-based liquid;
a flammable liquid;
a oil-based liquid; and
a combination of liquid and particulate matter.

18. A method of making a decorative glass vessel, comprising the steps of:
heating a first glass material;
blowing the first glass material to form a hollow interior glass article;
forming a first attachment portion at a base of the interior glass article;
forming a first access port in the interior glass vessel;
heating a second glass material;
blowing the second glass material to form a hollow exterior glass article;
forming a second access port in the exterior glass vessel;
forming a second attachment point at a base of the exterior glass article;
inserting the interior glass article into the exterior glass article;
coupling the interior glass article to the exterior glass article by fusing the first attachment portion to the second attachment portion; and
decorating the glass vessel by reverse hand-painting an image on an interior surface of the interior glass article.

19. The method according to claim 18, further comprising the steps of:
decorating the glass vessel by reverse hand-painting an image on an interior surface of the exterior glass article.

20. The method according to claim 18, further comprising the steps of:
adding a substance through the second access port to amplify the image on the interior surface of the interior glass article.
